(19) United States
(12) Patent Application Publication
(10) Pub. No.: US 2022/0156736 A1
(43) Pub. Date: May 19, 2022

(54) PAYMENT TRANSACTION HANDLING IN A RADIO COMMUNICATION NETWORK

(71) Applicant: Telefonaktiebolaget LM Ericsson (publ), Stockholm (SE)

(72) Inventors: Darwin CHANDRAN, Chennai (IN); M RAMKRISHNA, Chennai (IN); K B ARAVIND VIKIRAM, Chennai (IN)

(21) Appl. No.: 17/440,463

(22) PCT Filed: Mar. 20, 2019
(86) PCT No.: PCT/IN2019/050227

§ 371 Date: Sep. 17, 2021

(51) Int. Cl. G06Q 20/38; G06Q 20/32; G06Q 20/02

(52) U.S. Cl. CPC G06Q 20/3829; G06Q 20/325; G06Q 20/4014; G06Q 20/027; G06Q 20/389

(57) ABSTRACT

A method for payment transaction handling in a radio communication network is presented. The method is performed in a billing support node. The method includes receiving a payment indication from a third party node of a plurality of predefined third party nodes, generating a cryptographic key by combining a plurality of different identifiers identified in the received payment indication, and checking if the generated cryptographic key is new or already known in the billing support node. When the generated cryptographic key is new the method includes storing a backup of the payment indication in a blockchain, and setting a transaction state of the payment indication to indicate a new transaction. When the generated cryptographic key is already known the method includes rejecting the payment indication. A billing support node, a computer program and a computer program product for payment transaction handling in a radio communication network are also presented.

### TECHNICAL FIELD

The present disclosure relates to a method, a billing support node, a computer program and a computer program product for payment transaction handling in a radio communication network.

### BACKGROUND

Incoming payment transactions are in radio communication networks received from various sources and there are many possibilities for handling of duplicate transactions and many possibilities for single point failure as it is stored in a centralized database.

### SUMMARY

One objective is to enable payment transaction handling in a radio communication network the efficiently handle duplicate transaction and single point failures.

According to a first aspect there is presented a method for payment transaction handling in a radio communication network. The method is performed in a billing support node. The method comprises receiving a payment indication from a third party node of a plurality of predefined third party nodes, generating a cryptographic key by combining a plurality of different identifiers identified in the received payment indication, and checking if the generated cryptographic key is new or already known in the billing support node. When the generated cryptographic key is new the method comprises storing a backup of the payment indication in a blockchain, and setting a transaction state of the payment indication to indicate a new transaction. When the generated cryptographic key is already known the method comprises rejecting the payment indication.

The backup may be stored in a distributed database, wherein payment indications from a third party node are stored in a database separate from payment indications from other third party nodes.

The plurality of different identifiers may comprise two or more of the following: a processing timestamp, a customer ID, a contract ID, a service ID, a transaction ID, and a transaction timestamp.

The transaction state may be set in a transaction database common for all the plurality of third party nodes.

The method may further comprise receiving a new state request from a payment reader for payment indications with transaction state indicated as a new transaction, sending an indication of the requested payment indications with transaction state indicated as a new transaction to the payment reader, receiving a request from the payment reader for update of requested payment indications to transaction state indicated as an old transaction, and updating the requested payment indications from indicated as new transactions to indicated as old transactions.

The third party nodes may be predefined through blockchaining.

The received payment indication may be blockchained to previous payment indications from the same third party node.

According to a second aspect there is presented a billing support node for payment transaction handling in a radio communication network. The billing support node comprises a processing circuitry and a computer program product. The computer product stores instructions that, when executed by the processing circuitry, causes the billing support node to receive a payment indication from a third party node of a plurality of predefined third party nodes, generate a cryptographic key by combining a plurality of different identifiers identified in the received payment indication, and to check if the generated cryptographic key is new or already known in the billing support node. When the generated cryptographic key is new the billing support node is caused to store a backup of the payment indication in a blockchain, and to set a transaction state of the payment indication to indicate a new transaction. When the generated cryptographic key is already known the billing support node is caused to reject the payment indication.

The billing support node may be caused to store the backup in a distributed database, wherein payment indications from a third party node are caused to be stored in a database separate from payment indications from other third party nodes.

The plurality of different identifiers may comprise two or more of the following: a processing timestamp, a customer ID, a contract ID, a service ID, a transaction ID, and a transaction timestamp.

The transaction state may be set in a transaction database common for all the plurality of third party nodes.

The billing support node may further be caused to receive a new state request from a payment reader for payment indications with transaction state indicated as a new transaction, send an indication of the requested payment indications with transaction state indicated as a new transaction to the payment reader, receive a request from the payment reader for update of requested payment indications to transaction state indicated as an old transaction, and to update the requested payment indications from indicated as new transactions to indicated as old transactions.

The third party nodes may be predefined through blockchaining.

The received payment indication may be blockchained to previous payment indications from the same third party node.

According to a third aspect there is presented a computer program for payment transaction handling in a radio communication network. The computer program comprises computer program code which, when run in a billing support node, causes the billing support node to receive a payment indication from a third party node of a plurality of predefined third party nodes, generate a cryptographic key by combining a plurality of different identifiers identified in the received payment indication, and to check if the generated cryptographic key is new or already known in the billing support node. When the generated cryptographic key is new the billing support node is caused to store a backup of the payment indication in a blockchain, and to set a transaction state of the payment indication to indicate a new transaction in a transaction database common for all the plurality of third party nodes. When the generated cryptographic key is already known the billing support node is caused to reject the payment indication.

A computer program product comprising a computer program a computer readable storage means on which the computer program is stored is also presented.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a diagram schematically illustrating handling processing of telecommunication payment transaction data;

FIG. 2 is a diagram schematically illustrating a telecommunication payment transaction handler network;

FIG. 3 is a diagram schematically illustrating a generating cryptographic key algorithm;

FIG. 4 is a flowchart schematically illustrating embodiments of methods as presented herein;

FIG. 5 is a diagram schematically illustrating some components of a device presented herein; and

FIG. 6 is a diagram schematically illustrating functional module of a device presented herein.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Incoming telecommunication payments of a plurality of third party transactions are, in radio communication networks, typically processed by various sources captured from a plurality of third party financial gateway vendors in a centralized network. Duplicate transaction can be captured for a specific customer as all transactions are typically maintained in a centralized database. Each third party transaction can be captured from different third party networks and then uploaded in the centralized database, however still providing possibilities for inconsistency database problem, and an additional check for duplicate transaction can thus be made. For maintaining status of third party transactions, to be further processed by any arbitrary payment handler, a separate logic can be implemented and this can be repeated for all sources in a distributed manner.

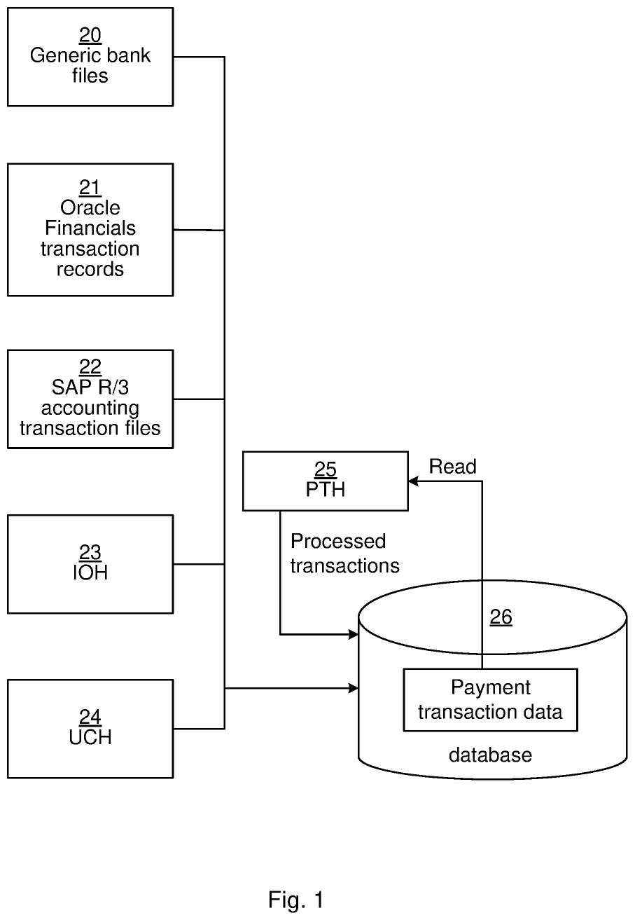

FIG. 1 Illustrates a plurality of possible sources for payment transaction data: generic bank files 20, Oracle financial transaction records 21, SAP R/3 accounting transaction files 22, Invoice output handler (IOH) files 23, and Unapplied Cash Handler (UCH) files 24. Each separate type of payment transaction data is here stored in a centralized database 26. The payment transaction data can then be read by a payment transaction handler (PTH) 25, which processes the transaction and returns processed transaction to the centralized database.

Chaincoding can be used to keep track of payment transaction data. Hyperledger Fabric is e.g. a blockchain framework hosted by The Linux Foundation, which uses leverages container technology to host smart contracts, called chaincode, that comprise an application logic of the system. Hyperledger Composer is used to create a transaction network definition, which comprises Model(.cto) for Incoming payment transactions, Script(.js) for Transaction Functions, ACL(.acl) for Access Control rules, and Query(.qry) for Query Definitions. Hyperledger Indy is a Distributed Ledger, with the purpose to be built for decentralized identity of transactions stored across a transaction network.

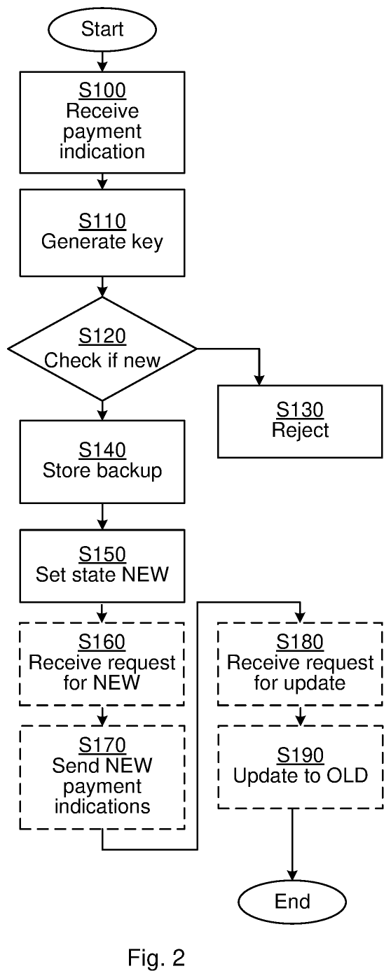

According to an aspect, an embodiment of a method for payment transaction handling in a radio communication network is presented with reference to FIG. 2. The method is performed in a billing support node 1 of a radio communication network. In processing block S100 a payment indication is received from a third party node of a plurality of predefined third party nodes. In processing block S110 a cryptographic key is generated by combining a plurality of different identifiers, each identified in the payment indication received in processing block S100. In processing block S120 it is checked if the generated cryptographic key is new or already known in the billing support node. When the generated cryptographic key is new, processing blocks S140 and S150 are performed. In processing block S140 a backup of the payment indication is stored in a blockchain. In processing block S150 a transaction state of the payment indication is set to indicate a new transaction. When the generated cryptographic key is already known, the payment indication is rejected in processing block S160.

The backup may be stored in a distributed database, wherein payment indications from a third party node are stored in a database separate from payment indications from other third party nodes.

The plurality of different identifiers may comprise two or more of the following identifiers: a processing timestamp, a customer ID, a contract ID, a service ID, a transaction ID, and a transaction timestamp.

The transaction state may be set in a transaction database common for all the plurality of third party nodes.

The method may further comprise processing blocks S160-S190. In processing block S160 a new state request is received from a payment reader for payment indications with transaction state indicate a new transaction. In processing block S170 an indication of the requested payment indications with transaction state indicated as a new transaction is sent to the payment reader. In processing block S180 a request from the payment reader is received for update of requested payment indications to transaction state indicated as a new transaction. In processing block S190 the requested payment indications is updated from indicated as new transactions to indicate as old transactions.

The third party nodes may be predefined through blockchaining.

The received payment indication may be blockchained to previous payment indications from the same third party node.

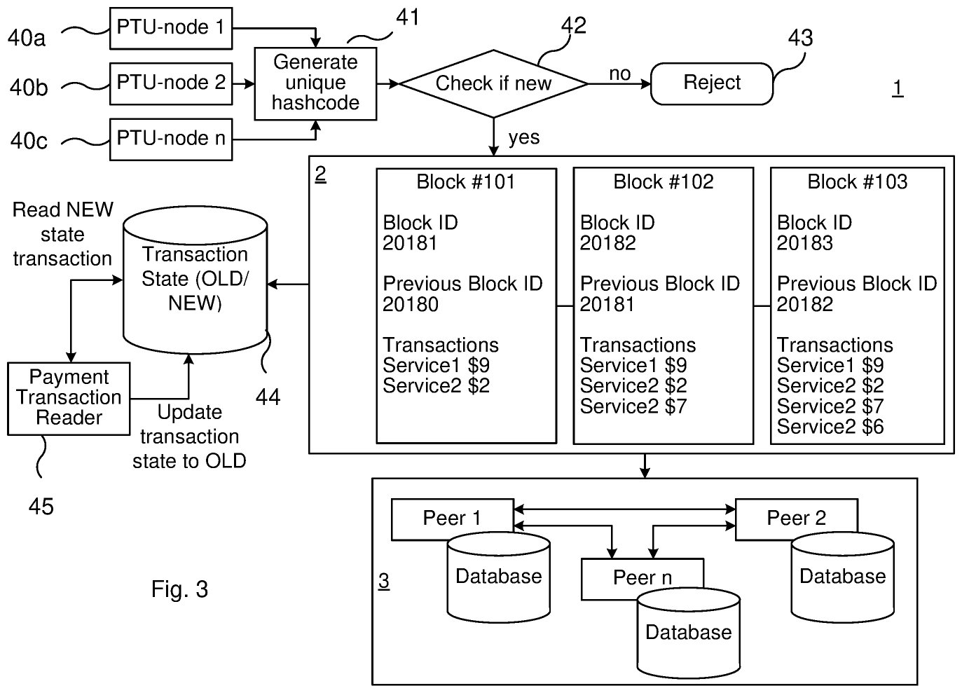

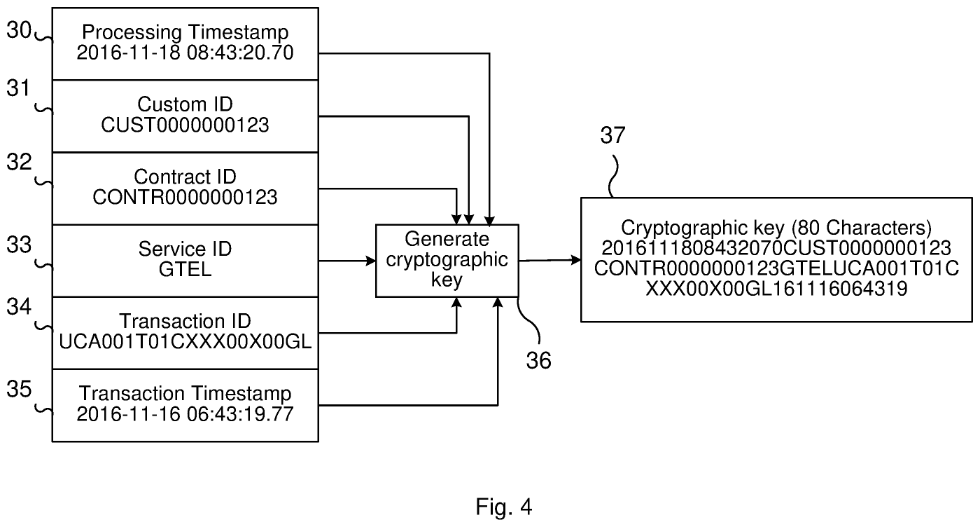

The operations shown in FIG. 2 will now be illustrated and described in more detail in conjunction with FIGS. 3 and 4.

Details of payment transaction handling in a radio communication network are next presented with reference to FIG. 3.

A plurality of payment transaction handler nodes are predefined for a business support node 1 by being configured in a separate permission blockchain business network, a peer-to-peer network. Only predefined payment transaction handler node transactions will be processed, and no other nodes are allowed in this network. All sources, related to incoming payment third party transactions in telecommunication, likely comprises a continuously growing list of records, called blocks, and are linked and secured using cryptographic algorithms. Predefined Payment Transactions Uploads nodes (PTU-nodes) 1-n are here processed and a unique hash code, or cryptographic key, is generated for each upload.

The unique cryptographic key is generated for each incoming payment transactions received from the various PTU nodes 40a, 40b and 40c, by combining a plurality of different identifiers and by implementing a transaction rulesets in a smart contract 41. The unique cryptographic key helps a transaction to be unique in the network and avoids processing of duplicate transactions in the business support node 1. The cryptographic algorithm is implemented by combining a Processing Timestamp 30, a Customer ID 31, a Contract ID 32, a Service ID 33, a Transaction ID 34 and a timestamp of the transaction ID 35, based on the logic smart contract ruleset 36, to generate a hash code of 80 character's cryptographic key 37, which is illustrated with an example in FIG. 4.

The smart contract further comprises a computer code running on top of a blockchain containing a set of rulesets 42 to check with a blockchain network whether the received transaction is new (unique) or a duplicate of the generated cryptographic key. If the received transaction is unique, then the transaction is moved to private blockchain network 2 and is stored in distributed ledger 3. The distributed ledger 3 is a decentralized backup database, wherein each peer 1-n has its own database. If the generated cryptographic key is not unique, the upload is instead rejected 43. The smart contract is thus validated with cryptographic keys across the plurality of nodes peer 1-peer n on the peer-to-peer network.

When the private blockchain network 2 receives a new transaction, the private blockchain network 2 generates a new block, here #103, for the latest transaction for the latest block ID. This new block #103 is chained to previous blocks #102, #101 and #100 (not illustrated) for the same user.

Another ruleset implemented in the smart contract of the business support node 1 is used to maintain a transaction status in a transaction state table or database 44. Each valid transaction moved to the private blockchain network 2 is also stored in the transaction state database 44, whereby a payment transaction reader 45 later on can retrieve the transaction. Each transaction thus replicates and saves an identical copy of the valid third party transaction and constructs the new chained transaction on each node for non-duplicate transaction and maintains an indication of a new transaction, the Transaction_State NEW, to indicate with the corresponding transaction cryptographic key.

The purpose of maintaining a separate relational database 44 for maintaining a generic transaction state is that transactions stored in the distributed ledger database 3 is immutable and cannot be edited or deleted.

A payment transaction reader 45 queries, before retrieving transactions from the business support system 1, the transaction state database 44 for new state transactions, retrieves the corresponding cryptographic keys and retrieves the cryptographic key related transaction from distributed ledger database 3.

After NEW state transactions have been retrieved from the transaction state database, the payment transaction reader updates the corresponding statuses to indicate an old transaction, Transaction_State to OLD by updating the transaction state database with corresponding transaction hash codes, and by this repeated transactions reading can be avoided.

The presented business support node will reduce many repetitive processes involved for capturing incoming payment transactions, and will also eliminate duplicate payment transaction. Double entries for the same transaction is not possible, as secondary level validation implemented with smart contract will perfectly validate with the cryptographic key for each new transaction captured and will not allow any duplicate transaction identified in the block chain network.

No additional logic would further need to be defined to identify a system crash during incoming payment processing since there is no possibility for single point failure due to the decentralized network. The centralized or global transaction state is being maintained for the further transaction processing done by payment transaction readers.

Since each transaction has the pervious transaction cryptographic key, there are no possibilities for tampering these transactions.

The payment transaction reader need not check whether received third party transaction is a duplicate or not, whereby a significant reduction of utilization in processor and storage is achieved.

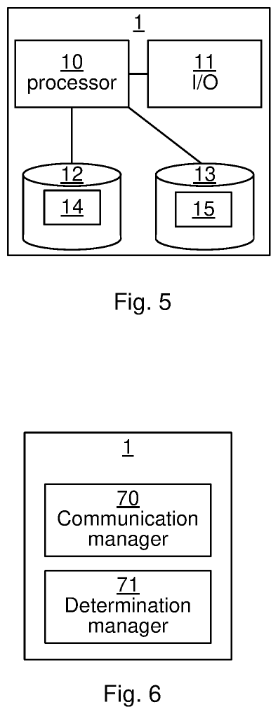

An embodiment of a billing support node for payment transaction handling in a radio communication network is presented with reference to FIG. 5. The billing support node 1 comprises a processing circuitry 10 and a computer program product 12, 13 storing instructions 14, 15. When the stored instructions are executed by the processing circuitry, the billing support node is caused to receive a payment indication from a third party node of a plurality of predefined third party nodes, generate a cryptographic key by combining a plurality of different identifiers identified in the received payment indication, check if the generated cryptographic key is new or already known in the billing support node, and to when the generated cryptographic key is new store a backup of the payment indication in a blockchain, and set a transaction state of the payment indication to indicate a new transaction, and when the generated cryptographic key is already known reject the payment indication.

The billing support node may be caused to store the backup in a distributed database, wherein payment indications from a third party node are caused to be stored in a database separate from payment indications from other third party nodes.

The plurality of different identifiers may comprise two or more of the following identifiers: a processing timestamp, a customer ID, a contract ID, a service ID, a transaction ID, and a transaction timestamp.

The transaction state may be set in a transaction database common for all the plurality of third party nodes.

The billing support node may further be caused to receive a new state request from a payment reader for payment indications with transaction state indicated as a new transaction, send an indication of the requested payment indications with transaction state indicated as a new transaction to the payment reader, receive a request from the payment reader for update of requested payment indications to transaction state indicated as an old transaction, and to update the requested payment indications from indicated as new transactions to indicated as old transactions.

The third party nodes may be predefined through blockchaining.

The received payment indication may be blockchained to previous payment indications from the same third party node.

FIG. 5 is a schematic diagram showing some components of the billing support node 1. The processing circuitry 10 may be provided using any combination of one or more of a suitable central processing unit, CPU, multiprocessing circuitry, microcontroller, digital signal processing circuitry, DSP, application specific integrated circuit etc., capable of executing software instructions of a computer program 14 stored in a memory. The memory can thus be considered to be or form part of the computer program product 12. The processing circuitry 10 may be configured to execute methods described herein with reference to FIG. 2.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processing circuitry 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the billing support node 1.

The billing support node 1 may further comprise an input/output (I/O) interface 11 including e.g. a user interface. The billing support node 1 may further comprise a receiver configured to receive signalling from other nodes, and a transmitter configured to transmit signalling to other nodes (not illustrated). Other components of the billing support node 1 are omitted in order not to obscure the concepts presented herein.

An embodiment of a billing support node 1 for payment transaction handling in a radio communication network is presented with reference to FIG. 6. The billing support node 1 comprises an communication manager 70 for processing blocks receiving S100 a payment indication from a third party node of a plurality of predefined third party nodes, and for, when a generated cryptographic key is already known, rejecting S130 the payment indication. The billing support node 1 also comprises a determination manager 71 for generating S110 a cryptographic key by combining a plurality of different identifiers identified in the received payment indication, checking S120 if the generated cryptographic key is new or already known in the billing support node, and when the generated cryptographic key is new, storing S140 a backup of the payment indication in a blockchain, and setting S150 a transaction state of the payment indication to indicate a new transaction.

FIG. 6 is a schematic diagram showing functional blocks of the billing support node 1. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the method illustrated in FIG. 2, comprising a communication manager unit 70 and a determination manger unit 71. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manager 70 is for payment transaction handling in a radio communication network. This module corresponds to the step S100, S130, S160, S170, S180, and S190 of FIG. 2. This module can e.g. be implemented by the processing circuitry 10 of FIG. 5, when running the computer program.

The determining manger 71 is for payment transaction handling in a radio communication network. This module corresponds to the steps S110, S120, S140, and S150 of FIG. 2. This module can e.g. be implemented by the processing circuitry 10 of FIG. 5, when running the computer program.

A computer program 14,15 for payment transaction handling in a radio communication network is presented with reference to FIG. 5. The computer program comprises computer program code which, when run in a billing support node 1, causes the billing support node to receive a payment indication from a third party node of a plurality of predefined third party nodes, generate a cryptographic key by combining a plurality of different identifiers identified in the received payment indication, check if the generated cryptographic key is new or already known in the billing support node, and to, when the generated cryptographic key is new, store a backup of the payment indication in a blockchain, and to set a transaction state of the payment indication to indicate a new transaction, and when the generated cryptographic key is already known to reject the payment indication.

A computer program product 12, 13 comprising a computer program 14, 15 and a computer readable storage means on which the computer program 14, 15 is stored, is also presented.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A method for payment transaction handling in a radio communication network, the method being performed in a billing support node, and comprising:
receiving a payment indication from a third party node of a plurality of predefined third party nodes;
generating a cryptographic key by combining a plurality of different identifiers identified in the received payment indication;
checking if the generated cryptographic key is new or already known in the billing support node; and
when the generated cryptographic key is new:
storing a backup of the payment indication in a blockchain; and
setting a transaction state of the payment indication to indicate a new transaction;
when the generated cryptographic key is already known:
rejecting the payment indication.

2. The method according to claim 1, wherein the backup is stored in a distributed database, wherein payment indications from a third party node are stored in a database separate from payment indications from other third party nodes.

3. The method according to claim 1, wherein the plurality of different identifiers comprises two or more of the following: a processing timestamp, a customer ID, a contract ID, a service ID, a transaction ID, and a transaction timestamp.

4. The method according to claim 1, wherein the transaction state is set in a transaction database common for all the plurality of third party nodes.

5. The method according to claim 1, further comprising:
receiving a new state request from a payment reader for payment indications with transaction state indicated as a new transaction;
sending an indication of the requested payment indications with transaction state indicated as a new transaction to the payment reader;
receiving a request from the payment reader for update of requested payment indications to transaction state indicated as an old transaction; and
updating the requested payment indications from indications as new transactions to indications as old transactions.

6. The method according to claim 1, wherein the third party nodes are predefined through blockchaining.

7. The method according to claim 1, wherein the received payment indication is blockchained to previous payment indications from the same third party node.

8. A billing support node for payment transaction handling in a radio communication network, the billing support node comprising:
a processing circuitry; and
a computer program product storing instructions that, when executed by the processing circuitry, causes the billing support node to:
receive a payment indication from a third party node of a plurality of predefined third party nodes;
generate a cryptographic key by combining a plurality of different identifiers identified in the received payment indication;
check if the generated cryptographic key is new or already known in the billing support node; and
when the generated cryptographic key is new:
store a backup of the payment indication in a blockchain; and
set a transaction state of the payment indication to indicate a new transaction;
when the generated cryptographic key is already known:
reject the payment indication.

9. The billing support node according to claim 8, wherein the billing support node is caused to store the backup in a distributed database, wherein payment indications from a third party node are caused to be stored in a database separate from payment indications from other third party nodes.

10. The billing support node according to claim 8, wherein the plurality of different identifiers comprises two or more of: processing timestamp, a customer ID, a contract ID, a service ID, a transaction ID, and a transaction timestamp.

11. The billing support node according to claim 8, wherein the transaction state is set in a transaction database common for all the plurality of third party nodes.

12. The billing support node according to claim 8, the billing support node further being caused to:
receive a new state request from a payment reader for payment indications with transaction state indicated as a new transaction;
send an indication of the requested payment indications with transaction state indicated as a new transaction to the payment reader;
receive a request from the payment reader for update of requested payment indications to transaction state indicated as an old transaction; and
update the requested payment indications from indicated as new transactions to indicated as old transactions.

13. The billing support node according to claim 8, wherein the third party nodes are predefined through blockchaining.

14. The billing support node according to claim 8, wherein the received payment indication is blockchained to previous payment indications from the same third party node.

15. A computer program for payment transaction handling in a radio communication network, the computer program comprising computer program code which, when run in a billing support node, causes the billing support node to:
receive a payment indication from a third party node of a plurality of predefined third party nodes;
generate a cryptographic key by combining a plurality of different identifiers identified in the received payment indication;
check if the generated cryptographic key is new or already known in the billing support node; and
when the generated cryptographic key is new:
store a backup of the payment indication in a blockchain; and
set a transaction state of the payment indication to indicate a new transaction;
when the generated cryptographic key is already known:
reject the payment indication.

16. A computer storage medium storing an executable computer program that, when executed, performs a method in a billing support node for payment transaction handling in a radio communication network, the method comprising:
receiving a payment indication from a third party node of a plurality of predefined third party nodes;
generating a cryptographic key by combining a plurality of different identifiers identified in the received payment indication;
checking if the generated cryptographic key is new or already known in the billing support node; and
when the generated cryptographic key is new:
storing a backup of the payment indication in a blockchain; and
setting a transaction state of the payment indication to indicate a new transaction;
when the generated cryptographic key is already known:
rejecting the payment indication.

17. The method according to claim 2, wherein the plurality of different identifiers comprises two or more of the following: a processing timestamp, a customer ID, a contract ID, a service ID, a transaction ID, and a transaction timestamp.

18. The method according to claim 2, wherein the transaction state is set in a transaction database common for all the plurality of third party nodes.

19. The method according to claim 2, further comprising:
receiving a new state request from a payment reader for payment indications with transaction state indicated as a new transaction;
sending an indication of the requested payment indications with transaction state indicated as a new transaction to the payment reader;
receiving a request from the payment reader for update of requested payment indications to transaction state indicated as an old transaction; and
updating the requested payment indications from indications as new transactions to indications as old transactions.

20. The method according to claim 2, wherein the third party nodes are predefined through blockchaining.
